(19) United States
(12) Patent Application Publication
(10) Pub. No.: US 2011/0173277 A1
(43) Pub. Date: Jul. 14, 2011

(54) METHOD OF AUTHENTICATING A USER OF A SERVICE ON A MOBILE TERMINAL

(76) Inventors: Pierre Cordani, Paris (FR); Laurent Hiriart, Paris (FR)

(21) Appl. No.: 13/001,341

(22) PCT Filed: Jun. 25, 2009
(86) PCT No.: PCT/EP2009/057987

§ 371 Date: Mar. 8, 2011

(30) Foreign Application Priority Data
Jun. 25, 2008 (FR) 0854209

(51) Int. Cl. G06F 15/16

(52) U.S. Cl. 709/206

(57) ABSTRACT

In the held of the broadcasting of services, in particular video, on mobile terminals and more particularly that of the method of authenticating the user of a service from a mobile terminal, the invention proposes a procedure for authenticating the user of a service on a mobile terminal making it possible to refrain from manual copying of an identifier by the user. For this purpose, the user enters his mobile telephone number when he registers. A short text message or an e-mail is then sent to him on his mobile terminal. This short message or e-mail contains an identifier of this user's account. When initially launching the application dedicated to access to the service, said application then runs through the short messages or e-mails stored on the terminal, it identifies the message containing the identifier and extracts it.

The present invention concerns the field of the broadcasting of services, in particular video, on a mobile terminal and more particularly the method of authenticating the user of a service from a mobile terminal.

These services generally consist of contents made available by distant servers. The service is also managed by a distant server. Access to the service requires an application dedicated to this access on the mobile terminal.

Generally, the process of registering for the service takes place from a computer connected to the internet on a registration service of the operator. This registration service is thus widely available. Moreover, the registration process is thus much more user friendly than from the mobile terminal.

Once registered for the service, the user must download an application onto his mobile terminal, typically a telephone, in order to be able to access the service. This application depends on the type of terminal possessed by the user. This is because many terminals exist and have service rendition capabilities that are very different from one terminal to another. In particular, the size of the screen, the number of colours that it can reproduce, the computing capacity that it has available and the quantity of memory that can be used are many criteria that directly influence the application dedicated to access to the service.

Installing the service therefore requires firstly determining the type of terminal used. Secondly, once this application is installed, it is necessary for it to able to access the account of the user. This access is necessary because of the need to know the extent of the service to which he has subscribed, as well as a certain number of parameters that he will have been able to define, relating to his subscription. It is therefore necessary to authenticate the user of the service in order to establish a link between the account of the user created on the internet from a computer and the application dedicated to access to the service on the mobile terminal.

The most used method for authenticating the user of a service consists of asking him, at the time of each access to the service, to authenticate himself by a password-protected name. This method is experienced as restricting by the user. It is then possible to seek to replace this authentication by the use of an identifier of the mobile.

In this context, two ways of authenticating the user of a service from a mobile terminal are known. The first consists of requesting the user to enter an identifier of his mobile terminal when his account is created on the internet. This identifier may, for example, be the IMEI (International Mobile Equipment Identity) number identifying the terminal uniquely. The user must then extract this identifier of the terminal by entering a combination of keys and copying it without error. Since the identifier is long, this procedure is off-putting and a source of error.

A second way of proceeding is to attribute a unique identifier to the user when he registers. The user is then responsible for noting this identifier. When the application dedicated to access to the service from mobile is first used, he is requested to enter this identifier, which makes the link between the mobile and the associated user account. Here also, the procedure is off-putting and a source of error for the user.

The invention aims to solve the above problems by proposing a procedure for authenticating the user of a service on a mobile terminal making it possible to dispense with a manual copying of an identifier by the user. For this purpose, the user enters his mobile telephone number when he registers. A short text message or an email is then sent to him on his mobile terminal. This short message or email contains an identifier of the account of this user. When the application dedicated to access to the service is initially launched, it then runs through the short messages or emails stored on the terminal and indentifies the message containing the identifier and extracts it.

In this way, a link is automatically created between the account created on the internet by the user and the mobile terminal used without needing to copy an abstruse identifier either during registration or during installation of the service. This method of authenticating the user is particularly secure, since it is based on a hardware identifier of the terminal.

The invention concerns a method of authenticating a user of a service on a mobile terminal, the said service involving the use on the terminal of an application dedicated to access to the service, the said service being managed by a distant server, which comprises a step of reception by the terminal of a message sent by the distant server comprising an identifier of the user account; and by an application dedicated to access to the service, a step of seeking the identifier of the user account in the messages received on the terminal; a step of extracting an identifier of the terminal and a step of sending to the server a request containing both the identifier of the terminal and the identifier of the user account.

According to a particular embodiment of the invention, the message received by the terminal also contains a reference to the dedicated application that is to be used.

According to a particular embodiment of the invention, the identifier of the user account received is a session identifier containing an encrypted version of the actual identifier of the account.

According to a particular embodiment of the invention, it also comprises a step of sending of a first request to the server by the dedicated application containing the identification of the terminal, the steps of seeking and sending the identifier of the account being performed only following the reception of a message from the server indicating failure of the association between the identifier of the terminal sent and the account of the user.

According to a particular embodiment of the invention, in the case of failure of the step for searching for the identifier of the user account in the messages received on the terminal, this identifier is requested of the user by the dedicated application.

According to a particular embodiment of the invention, it also comprises a step of reception by the dedicated application of a default configuration that is to be used by the application in the event of failure of the authentication of the user.

The invention also concerns a mobile terminal comprising means of authenticating a user of a service on the said mobile terminal, the said service involving the use on the terminal of an application dedicated to access to the service, the said service being managed by a distant server, which comprises means of reception by the terminal of a message sent by the distant server comprising an identifier of the user account and an application dedicated to access to the service, which itself comprises means of searching for the identifier of the user account in the messages received on the terminal; means of extracting an identifier of the terminal and means of sending to the server a request containing both the identifier of the terminal and the identifier of the user account.

The features of the invention mentioned above, as well as others, will emerge more clearly from a reading of the following description of an example embodiment, the said description being given in relation to the accompanying drawings, among which:

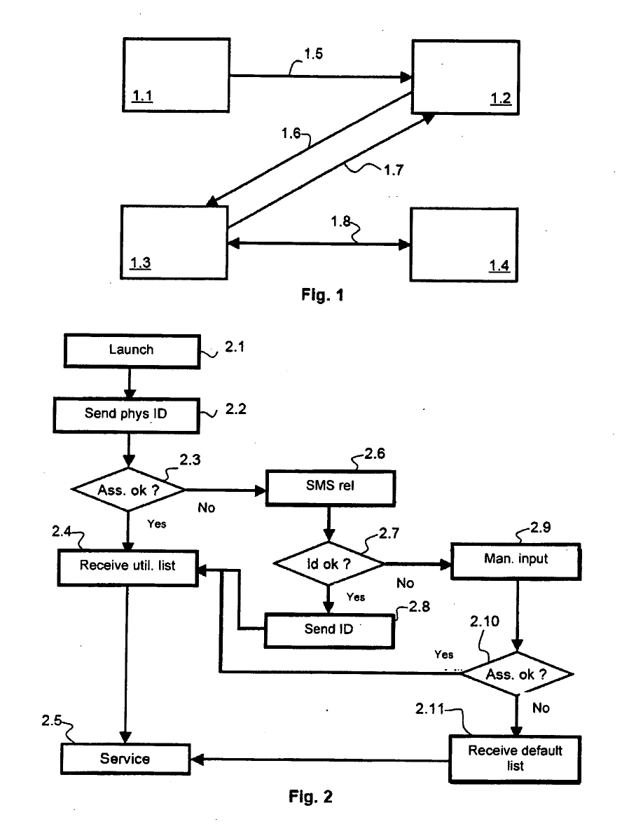

FIG. 1 describes the participants and the general operating procedure of the service.

FIG. 2 describes the functioning of the sequence of initialisation of the application in an example embodiment of the invention.

The invention is situated in the context of the supply of services to a user on a mobile terminal. The mobile terminal according to the invention may be a mobile telephone, a communicating personal assistant or any apparatus affording access to a communication network for receiving the service. The service may for example consist of broadcasting video on demand.

FIG. 1 illustrates the general procedure of the registration of a user for the service. Firstly, the user must register for the service. This registration operation is typically performed using the Web site 1.2 of the service operator. The user uses a means 1.1 of accessing the internet site of the operator, generally a microcomputer having an internet browser. The user uses his browser for completing a registration form that contains data relating to his subscription. This information is sent 1.5 to the internet site of the operator. When he registers, the user personalises the service. He enters information concerning his tastes, or he establishes a list of contents to which he subscribes. This is here spoken of as configuration, the configuration designates the environment, which may comprise graphics, thematic worlds, services, parental codes and the reading list that is a selection of preferred programs. This configuration represents a personalised version of the service as parameterised by the user according to his choices and the rights that he has acquired. It may be a case of a selection of preferred programs. It also contains the parameterising chosen by the user. The user also has a mobile terminal 1.3 intended to receive the service. In order to be able to use the service, an application dedicated to access to the service is downloaded onto this terminal. The operator has available a set of versions of this application adapted to various types of terminal. The user must therefore download onto his terminal the application version suited to it. When this application is launched, it sends a terminal identifier to the server 1.2 in the form of a message 1.7. The server must then make the link between the identifier of the mobile terminal received and the user account in order to find the configuration of the latter. This link being established, the configuration is then sent to the terminal by means of a message 1.6. This configuration has a set of contents available to the user. The latter can then choose one of them and initialise the retrieval of this content by sending a request to a content broadcasting server (streaming) 1.4. The broadcasting server can then broadcast the content chosen to the mobile terminal 1.3. These exchanges are referenced 1.8 in FIG. 1.

This scheme poses the problem of authentication of the user so that the service 1.2 can make the link between the identifier of the terminal received and the message 1.7 and the account of the user. There exist conventionally two ways of solving this difficulty. A first solution consists of attributing a unique number identifying the user when he registers. This number is then accessible to the user on his computer 1.1 during registration. He must then note it and is invited, at least when the application is first used on the terminal, to enter this number on the terminal. In this case, the request 1.7 contains, at least at the time of this first use, both the identifier of the terminal and the identifier of the user account. The service 1.2 is then capable of storing this association.

A second way of proceeding is to request the user to enter the identifier of his mobile terminal during the registration phase. This identifier is generally accessible to the user on his terminal. For example, if the identifier of the terminal used is the IMEI (International Mobile Equipment Identity) number attributed to mobile telephones, this is accessible by entering the code “*#06#” on his mobile. Once this code is known to the server and recorded in the parameters of the user account, the service is in a position to establish the link between an IMEI code received during a request 1.7 and the user account concerned.

This code is long and copying thereof is subject to error. Likewise, the copying onto the terminal of a user account identifier on the terminal is a manual procedure that is off-putting and subject to error.

To overcome these drawbacks, the invention proposes to request a messaging address of the user among the registration information. The site is in a position to send a message 1.6 to the user using this address. The type of address and messaging service may vary. According to the example embodiment of the invention, this address is a mobile telephone number and the message is then typically an SMS (Short Message Service) message. However, other messaging services may be used, and for example email can be cited, the reference then being the messaging address of the user. In any event, the messaging service must be available on the mobile terminal 1.3 of the user so that the message can be received and used on this terminal. The advantage is that the user generally knows his mobile telephone number or email address by heart and can therefore complete the registration form without having to have recourse to an external information source. The procedure is facilitated thereby and the risk of error reduced.

According to an example embodiment of the invention, the message sent by the service contains an identifier of the user account.

Prior to the first use of the application dedicated to access to the service on the mobile terminal, the user picks up his messages and therefore receives the message sent by the service containing the identifier of his account. The application is then in a position to access the messages stored on the mobile terminal. It can run through them seeking the message received from the service, the identification thereof taking place on a string of characters routinely present in the message. It can then extract from the message the identifier of the user account and send to the service a message containing this identifier and the identifier of the terminal. The service is then capable of storing the association between the identifier of the terminal and the identifier of the account. Any message subsequently sent from the terminal and containing the identifier thereof will be able to be associated by the service with the user account of the subscriber.

The particular implementation according to this principle may undergo variations without departing from the scope of the invention. The particular functioning of the example embodiment will now be described in relation to FIG. 2.

It is assumed in this example that the user has registered and has during this registration phase entered his mobile telephone number. He has also configured his service preferences and set up his particular configuration. He therefore has on the server of the service a functional and configured user account.

Consequently the service has sent an SMS to the user containing an identifier of the user account. Advantageously, this identifier is a session identifier that represents the identification number of the account in an encrypted manner, for example by means of a hash function. This identifier can advantageously be formed on request for single use for security reasons. Advantageously, the identifier of the terminal is also sent encrypted for security reasons.

Preferentially, the message also contains a reference for locating the version of the application dedicated to access to the service that is to be downloaded and installed on the mobile terminal. This reference may take the form of a URL (Unified Resource Locator) enabling the user to trigger downloading by a simple operation of selecting the reference within the message. Persons skilled in the art understand that any other way of locating and supplying the application to the terminal can be used in the context of the invention. In particular, a technique of sending a request for downloading of the application can be used. This request sent by the terminal containing the identifier of the terminal, in this case the IMEI, from this enables the service to identify the type of terminal and to supply in response the adapted version of the application. Following this operation, the adapted version of the application dedicated to access to the service is downloaded and installed on the terminal.

FIG. 2 describes the functioning of the dedicated application and more particularly the operations taking place at the launch thereof in order to obtain the configuration of the user. Following a first launch step 2.1, the application commences by extracting an identifier of the terminal. It then sends a request for configuration to the service during a step 2.2. This request contains this identifier of the terminal. In the example embodiment, it is a case of the IMEI identifier of the telephone. Other identifiers may be envisaged and will have the same functional role of identifying the terminal. The IMSI (International Mobile Subscribe Identity), which identifies the connection and is located in the SIM (Subscriber Identity Module) card, or the physical identifier of a memory card present in the terminal, can be cited for example. Advantageously, this identifier is an unfalsifiable physical identifier of the terminal or subscription of the user.

When the service receives such a request, it attempts to associate this request with a user account during step 2.3.

If this association succeeds, the service may find the configuration in the account of the user and send it to the terminal. The latter then receives this configuration during a step 2.4. The service can then be initialised and configured with this configuration and executed during step 2.5.

If the service is incapable of making the association between the terminal, identified by the identifier received in the request, and the account of the user, it responds with a request for a user account identifier. The application that receives this request then sets out to seek such an identifier during a step 2.6. This search is done by analysing the message base received in the terminal. If this identifier is found in the messages received, it is then sent to the service during a step 2.8.

The service can then associate the terminal and the user account and send the configuration, and step 2.4 for the application is returned to.

It may happen that the message containing the identifier of the user account is not found in the message base received on the terminal. This may have many causes. The number entered by the user is erroneous, the message has been picked up on another terminal, for example in the case where the SIM card has been installed in another terminal. Or the user has quite simply deleted the message on his terminal. It may also happen that the user has directly downloaded the application (from another mobile by a direct wireless communication for example (Bluetooth). In this case, when the application is first launched, the mobile sends its identifier to the server and, as it has not been registered in the server, the server returns an error message indicating that the user is unknown. The application then asks the user for his account number during a step 2.9. This request is made by opening a dialogue window on the terminal screen. The user can then enter his account identifier, which he can find on his online account from his computer or which he noted at the time of registration. During step 2.10, the service attempts to associate the identifier of the terminal and the account identifier that it has received. If this association succeeds, the configuration of the user is sent to the terminal, and step 2.4 of reception of the configuration by the terminal is returned to. If this association fails, signifying a failure of the user authentication procedure, a default configuration is then sent to the terminal, which receives it during a step 2.11. The service then starts, at step 2.5, with this default configuration.

In this way, the user can access the service without having to authenticate himself with his terminal. The authentication is done in a secure manner by a hardware identification of the terminal. The manipulations and manual copyings of identifiers by the user are reduced.

This method of authenticating the user using a service from a mobile terminal can also be used for payment operations from the mobile terminal. Given that the user is authenticated in a sure and unique manner by his terminal, a payment service is facilitated: the user having previously entered his bank details via his computer on the internet site in a secure manner, when the user makes a purchase from his mobile he has no need to re-enter his bank details since they are already recorded on the server. The user can then purchase a service from his mobile in all places covered by the network.

1. Method of authenticating a user of service on a mobile terminal, the said service involving the use on the terminal of an application dedicated to access to the service, the said service being managed by a distant server, characterised in that it comprises the following steps:
a step of reception by the terminal of a message sent by the distant server by a messaging service available on the mobile terminal and comprising an identifier of the user account;
and by an application dedicated to access to the server:
a step of seeking the identifier of a user account in the messages received on the terminal;
a step of extracting an identifier of the terminal;
a step of sending to the server a request containing both the identifier of the terminal and the identifier of the user account.

2. Method according to claim 1, characterised in that the message received by the terminal also contains a reference to the dedicated application that is to be used.

3. Method according to one of claim 1 or 2, characterised in that the identifier of the user account receives a session identifier containing an encrypted version of the actual identifier of the account.

4. Method according to one of claims 1 to 3, characterised in that it also comprises:
a step of sending a first request to the server by the dedicated application containing the identification of the terminal, the steps of seeking and sending the identifier of the account being performed only following the reception of a message from the server indicating the failure of the association between the identifier of the terminal sent and the account of the user.

5. Method according to one of claims 1 to 4, characterised in that, in the case of failure of the step of seeking the identifier of the user account in the messages received on the terminal, this identifier is requested of the user by the dedicated application.

6. Method according to claim 5, characterised in that it also comprises:
a step of reception by the dedicated application of a default configuration that is to be used by the application in the case of failure of the authentication of the user.

7. Mobile terminal comprising means of authenticating a user of a service on the said mobile terminal, the said service involving the use on the terminal of an application dedicated to access to the service, the said service being managed by a distant server, characterised in that it comprises:
means of reception by the terminal of a message sent by the distant server comprising an identifier of the user account; and
an application dedicated to access to the service, which itself comprises:
means of seeking the identifier of the user account in the messages received on the terminal;
means of extracting an identifier of the terminal;
means of sending to the server a request containing both the identifier of the terminal and the identifier of the user account.
